(19) United States
(12) Patent Application Publication
(10) Pub. No.: US 2025/0044082 A1
(43) Pub. Date: Feb. 6, 2025

(54) PRESS FORMING ANALYSIS METHOD, PRESS FORMING ANALYSIS APPARATUS, AND PRESS FORMING ANALYSIS PROGRAM

(71) Applicant: JFE STEEL CORPORATION, Tokyo (JP)

(72) Inventors: Takeshi OGAWA, Tokyo (JP); Satoshi SUMIKAWA, Tokyo (JP); Toyohisa SHINMIYA, Tokyo (JP); Yuji YAMASAKI, Tokyo (JP)

(73) Assignee: JFE STEEL CORPORATION, Tokyo (JP)

(21) Appl. No.: 18/719,451

(22) PCT Filed: Nov. 8, 2022
(86) PCT No.: PCT/JP2022/041518

§ 371 Date: Jun. 13, 2024

(30) Foreign Application Priority Data
Jan. 14, 2022 (JP) 2022-004081
Feb. 16, 2022 (JP) 2022-021760

(51) Int. Cl. G01B 21/20; B21D 53/88

(52) U.S. Cl. CPC G01B 21/20; B21D 53/88

(57) ABSTRACT

A press forming analysis method includes: (a) acquiring a shape of a standard press-formed part; (b) generating a waveform blank model; (c) acquiring a shape of a waveform blank press-formed part; (d) comparing the shape of the standard press-formed part and the shape of the waveform blank press-formed part, and obtaining a deviation amount of shape change; (e) generating one or more types of cycle deviation waveform blank models; (f) acquiring a shape of a cycle deviation waveform blank press-formed part; (g) comparing the shape of the standard press-formed part with one or more types of the shape of the cycle deviation waveform blank press-formed part, and obtaining a deviation amount of shape change; and (h) identifying, as a portion requiring countermeasures, a portion having a deviation amount of shape change exceeding a threshold among the deviation amounts of shape change obtained in (d) and (g).

### FIELD

The present invention relates to a press forming analysis method, a press forming analysis apparatus, and a press forming analysis program for predicting an effect of shape variation of a blank when press forming is performed using the blank collected from a metal sheet having the shape variation.

### BACKGROUND

Amid the improving collision safety of an automotive body due to tightening of collision safety standards for automobiles, weight reduction of an automotive body has also been required for improvement of fuel efficiency of an automobile in response to recent carbon dioxide emission regulations. In order to provide both the collision safety performance and the weight reduction of an automotive body, a metal sheet having strength higher than that in the conventional case is being adopted in the automotive body.

Conventionally, an actual metal sheet from which a blank for obtaining a press-formed part is collected is not completely flat but has a waveform (shape variation). Therefore, the actual blank collected from such a metal sheet is not also necessarily flat and may have shape variation.

When a metal sheet having such a waveform is used as a blank and press-formed into an automotive part, there is a concern that the shape variation of the press-formed part obtained after press forming would have an effect on dimensional accuracy, resulting in deviation from the target dimensional accuracy.

For example, Patent Literature 1 and Patent Literature 2 are disclosed as techniques for screening a press-formed part after press forming, which has a dimensional accuracy deviating from a target dimensional accuracy.

### CITATION LIST

### Patent Literature

Patent Literature 1: JP S62-047504 A
Patent Literature 2: JP 2019-002834 A

### SUMMARY

### Technical Problem

The technique disclosed in Patent Literature 1 or Patent Literature 2 compares the shapes of formed parts after press forming and cannot predict the effect of shape variation of a blank before press forming on a press-formed part after press forming. Conventionally, the effect of shape variation of a blank on the shape of a press-formed part has not been predicted, and identification has not been made regarding which portion of the press-formed part is susceptible to the shape variation of the blank.

A blank used for press forming is collected from a metal sheet such as a steel sheet by punching or shearing. Since the position at the time of collection from a metal sheet having shape variation is different, even in the case of a blank collected from the same metal sheet, portions exhibiting unevenness are different among the individual blanks. Therefore, consideration needs to be given to the difference in the shape variation of individual blanks in predicting the effect of the shape variation of the blank on the shape of the press-formed part.

The present invention has been made to solve the above problems, and an object of the present invention is to provide a press forming analysis method, a press forming analysis apparatus, and a press forming analysis program for predicting an effect of shape variation of a blank when press forming is performed using the blank collected from a metal sheet having shape variation.

### Solution to Problem

To solve the problem and achieve the object, a press forming analysis method according to the first aspect of the present invention is the press forming analysis method for predicting an effect of shape variation of a blank when press forming is performed using the blank collected from a metal sheet having the shape variation., the press forming analysis method includes: a shape acquisition step of a standard press-formed part of performing press forming analysis where press forming is performed with a predetermined tool of press forming model using a flat blank model that has a flat shape, and acquiring a shape of a press-formed part after die release as a shape of the standard press-formed part; a generation step of a waveform blank model of generating a waveform blank model having a waveform that has a predetermined wavelength and a predetermined amplitude corresponding to the shape variation; a shape acquisition step of a press-formed part using the waveform blank model of performing press forming analysis where press forming is performed with the predetermined tool of press forming model using the waveform blank model, and acquiring a shape of the press-formed part after die release as a shape of a waveform blank press-formed part; a first deviation amount acquisition step of comparing the shape of the standard press-formed part and the shape of the waveform blank press-formed part, and obtaining a portion where both the shapes are deviated from each other and a deviation amount of shape change; a generation step of a cycle deviation waveform blank model of generating one or more types of cycle deviation waveform blank models each having a waveform that has an amplitude identical to and a cycle deviated from the waveform in the waveform blank model; a shape acquisition step of a press-formed part using the cycle deviation waveform blank model of performing press forming analysis where press forming is performed with the predetermined tool of press forming model using the cycle deviation waveform blank model, and acquiring a shape of the press-formed part after die release as a shape of a cycle deviation waveform blank press-formed part; a second deviation amount acquisition step of comparing the shape of the standard press-formed part with one or more types of the shape of the cycle deviation waveform blank press-formed part, and obtaining a portion where both the shapes are deviated from each other and a deviation amount of shape change; and a step to identify portions requiring countermeasures of identifying, as a portion requiring countermeasures, a portion having a deviation amount of shape change exceeding a threshold among the deviation amounts of shape change obtained in the first deviation amount acquisition step and the second deviation amount acquisition step.

Moreover, the first deviation amount acquisition step may acquire, as the deviation amount of shape change, a difference between: a springback amount of a predetermined portion in the shape of the standard press-formed part; and a springback amount of the same portion in the shape of the waveform blank press-formed part as the predetermined portion in the shape of the standard press-formed part, and the second deviation amount acquisition step may acquire, as the deviation amount of shape change, a difference between: the springback amount of the predetermined portion in the shape of the standard press-formed part; and a springback amount of the same portion in the shape of the cycle deviation waveform blank press-formed part as the predetermined portion in the shape of the standard press-formed part.

Moreover, a press forming analysis method according to the second aspect of the present invention is the press forming analysis method for predicting an effect of shape variation of a blank when press forming is performed using the blank collected from a metal sheet having the shape variation. The press forming analysis method includes: a shape acquisition step of a standard press-formed part of performing press forming analysis where press forming is performed with a predetermined tool of press forming model using a flat blank model that has a flat shape, and acquiring a shape of a press-formed part after die release as a shape of the standard press-formed part; a first generation step of a first actual blank model of generating the first actual blank model on a basis of a measurement result obtained by measuring a shape of a first actual blank collected from a predetermined position of the metal sheet; a first shape acquisition step of a press-formed part using the first actual blank model of performing press forming analysis where press forming is performed with the predetermined tool of press forming model using the first actual blank model, and acquiring a shape of the press-formed part after die release as a first shape of an actual blank press-formed part; a first actual deviation amount acquisition step of comparing the shape of the standard press-formed part and the first shape of the actual blank press-formed part, and obtaining a portion where both the shapes are deviated from each other and a deviation amount of shape change; a second generation step of a second actual blank model of generating one or more types of second actual blank models on a basis of a measurement result obtained by measuring a shape or shapes of one or more of second actual blanks collected from a position of the metal sheet, the position being different from a position from which the first actual blank is collected; a second shape acquisition step of a press-formed part using the one or more types of second actual blank models of performing press forming analysis where press forming is performed with the predetermined tool of press forming model using the one or more types of second actual blank models, and acquiring a shape of the press-formed part after die release as a second shape of an actual blank press-formed part; a second actual deviation amount acquisition step of comparing the shape of the standard press-formed part with one or more types of the second shape of the actual blank press-formed part, and obtaining a portion where both the shapes are deviated from each other and a deviation amount of shape change; and a step to identify portions requiring countermeasures of identifying, as a portion requiring countermeasures, a portion having a deviation amount of shape change exceeding a threshold among the deviation amounts of shape change obtained in the first actual deviation amount acquisition step and the second actual deviation amount acquisition step.

Moreover, the first actual deviation amount acquisition step may acquire, as the deviation amount of shape change, a difference between: a springback amount of a predetermined portion in the shape of the standard press-formed part; and a springback amount of the same portion in the first shape of the actual blank press-formed part as the predetermined portion in the shape of the standard press-formed part, and the second actual deviation amount acquisition step may acquire, as the deviation amount of shape change, a difference between: the springback amount of the predetermined portion in the shape of the standard press-formed part; and a springback amount of the same portion in the second shape of the actual blank press-formed part as the predetermined portion in the shape of the standard press-formed part.

Moreover, a press forming analysis apparatus according to the first aspect of the present invention is the press forming analysis apparatus for predicting an effect of shape variation of a blank when press forming is performed using the blank collected from a metal sheet having the shape variation. The press forming analysis apparatus includes: a shape acquisition unit of a standard press-formed part, the shape acquisition unit being configured to perform press forming analysis where press forming is performed with a predetermined tool of press forming model using a flat blank model that has a flat shape, and acquire a shape of a press-formed part after die release as a shape of the standard press-formed part; a generation unit of a waveform blank model, the generation unit being configured to generate a waveform blank model having a waveform that has a predetermined wavelength and a predetermined amplitude corresponding to the shape variation; a shape acquisition unit of a press-formed part using the waveform blank model, the shape acquisition unit being configured to perform press forming analysis where press forming is performed with the predetermined tool of press forming model using the waveform blank model, and acquire a shape of the press-formed part after die release as a shape of a waveform blank press-formed part; a first deviation amount acquisition unit being configured to compare the shape of the standard press-formed part and the shape of the waveform blank press-formed part, and obtain a portion where both the shapes are deviated from each other and a deviation amount of shape change; a generation unit of a cycle deviation waveform blank model, the generation unit being configured to generate one or more types of cycle deviation waveform blank models each having a waveform that has an amplitude identical to and a cycle deviated from the waveform in the waveform blank model; a shape acquisition unit of a press-formed part using the cycle deviation waveform blank model, the shape acquisition unit being configured to perform press forming analysis where press forming is performed with the predetermined tool of press forming model using the cycle deviation waveform blank model, and acquire a shape of the press-formed part after die release as a shape of a cycle deviation waveform blank press-formed part; a second deviation amount acquisition unit being configured to compare the shape of the standard press-formed part with one or more types of the shape of the cycle deviation waveform blank press-formed part, and obtain a portion where both the shapes are deviated from each other and a deviation amount of shape change; and a unit to identify portions requiring countermeasures, the unit being configured to identify, as a portion requiring countermeasures, a portion having a deviation amount of shape change exceeding a threshold among the deviation amounts of shape change obtained in the first deviation amount acquisition unit and the second deviation amount acquisition unit.

Moreover, the first deviation amount acquisition unit may acquire, as the deviation amount of shape change, a difference between: a springback amount of a predetermined portion in the shape of the standard press-formed part; and a springback amount of the same portion in the shape of the waveform blank press-formed part as the predetermined portion in the shape of the standard press-formed part, and the second deviation amount acquisition unit may acquire, as the deviation amount of shape change, a difference between: the springback amount of the predetermined portion in the shape of the standard press-formed part; and a springback amount of the same portion in the shape of the cycle deviation waveform blank press-formed part as the predetermined portion in the shape of the standard press-formed part.

Moreover, a press forming analysis apparatus according to the second aspect of the present invention is the press forming analysis apparatus for predicting an effect of shape variation of a blank when press forming is performed using the blank collected from a metal sheet having the shape variation. The press forming analysis apparatus includes: a shape acquisition unit of a standard press-formed part, the shape acquisition unit being configured to perform press forming analysis where press forming is performed with a predetermined tool of press forming model using a flat blank model that has a flat shape, and acquire a shape of a press-formed part after die release as a shape of the standard press-formed part; a first generation unit of an actual blank model, the first generation unit being configured to measure a shape of a first actual blank collected from a predetermined position of the metal sheet, and generate a first actual blank model on a basis of a measurement result; a first shape acquisition unit of a press-formed part using the first actual blank model, the shape acquisition unit being configured to perform press forming analysis where press forming is performed with the predetermined tool of press forming model using the first actual blank model, and acquire a shape of the press-formed part after die release as a first shape of an actual blank press-formed part; a first actual deviation amount acquisition unit configured to compare the shape of the standard press-formed part and the first shape of the actual blank press-formed part, and obtain a portion where both the shapes are deviated from each other and a deviation amount of shape change; a second generation unit of an actual blank model, the second generation unit being configured to measure a shape or shapes of one or more second actual blanks collected from a position of the metal sheet, the position being different from a position from which the first actual blank is collected, and generate one or more types of second actual blank models on a basis of a measurement result; a second shape acquisition unit of a press-formed part using an actual blank, the shape acquisition unit being configured to perform press forming analysis when press forming is performed with the predetermined tool of press forming model using the one or more types of second actual blank models, the shape acquisition unit being configured to acquire a shape of the press-formed part after die release as a shape of the press-formed part using the one or more second actual blanks; a second actual deviation amount acquisition unit being configured to compare the shape of the standard press-formed part with one or more types of the second shape of the actual blank press-formed part, and obtain a portion where both the shapes are deviated from each other and a deviation amount of shape change; and a unit to identify portions requiring countermeasures, the unit being configured to identify, as a portion requiring countermeasures, a portion having a deviation amount of shape change exceeding a threshold among the deviation amounts of shape change obtained in the first actual deviation amount acquisition unit and the second actual deviation amount acquisition unit.

Moreover, the first actual deviation amount acquisition unit may acquire, as the deviation amount of shape change, a difference between: a springback amount of a predetermined portion in the shape of the standard press-formed part; and a springback amount of the same portion in the first shape of the actual blank press-formed part as the predetermined portion in the shape of the standard press-formed part, and the second actual deviation amount acquisition unit may acquire, as the deviation amount of shape change, a difference between: the springback amount of the predetermined portion in the shape of the standard press-formed part; and a springback amount of the same portion in the second shape of the actual blank press-formed part as the predetermined portion in the shape of the standard press-formed part.

Moreover, a press forming analysis program according to the present invention is the press forming analysis program causing a computer to function as the press forming analysis apparatus according to the present invention.

### Advantageous Effects of Invention

According to the present invention, it is possible to know a portion where the shape variation of a blank has a large effect on the shape of a press-formed part after springback and a deviation amount of shape change attributable to the shape variation of the blank in consideration of the difference in the shape variation of individual blanks. Whether a press-formed part is defective is determined on the basis of the deviation amount of shape change and a predetermined threshold, whereby whether a blank is defective can be predicted. As a result, it is possible to grasp the limit of the shape accuracy of a blank that falls within the range of the shape accuracy required for a press-formed part and to stably perform press forming that generates a favorable shape by screening a blank having an appropriate shape. In addition, when a shape defect of the press-formed part occurs, it is possible to identify which portion of the blank before press forming is causative of the shape defect, and countermeasures therefor can be taken promptly, leading also to improvement of productivity.

### BRIEF DESCRIPTION OF DRAWINGS

FIG. 1 is an explanatory diagram of each step of a press forming analysis method according to a first embodiment.

FIG. 2 is an external view of a part focused on in the first embodiment.

FIG. 3 is an explanatory view of a flat blank model used in the first embodiment.

FIG. 4 is an explanatory view of a shape of a standard press-formed part subjected to press forming analysis using the flat blank model of FIG. 3 (FIG. 4(a)) and a view illustrating an amount of shape change in FIG. 4(a) in correspondence with the flat blank model (FIG. 4(b)).

FIG. 5 is an explanatory view of a waveform blank model having a cyclic waveform.

FIG. 6 is an explanatory view of a shape of a waveform blank press-formed part subjected to press forming analysis using the waveform blank model of FIG. 5 (FIG. 6(a)) and a view illustrating an amount of shape change in FIG. 6(a) in correspondence with the flat blank model (FIG. 6(b)).

FIG. 7 is a view for explaining a deviation amount of shape change when the shape of a standard press-formed part in FIG. 4 is compared with the shape of a waveform blank press-formed part in FIG. 6.

FIG. 8 is an explanatory view of a cycle deviation waveform blank model having a waveform that has an amplitude identical to and a cycle deviated from the waveform of the waveform blank model of FIG. 5.

FIG. 9 is an explanatory view of a shape of a cycle deviation waveform blank press-formed part subjected to press forming analysis using the cycle deviation waveform blank model of FIG. 8 (FIG. 9(a)) and a view illustrating an amount of shape change in FIG. 9(a) in correspondence with the flat blank model (FIG. 9(b)).

FIG. 10 is a view for explaining a deviation amount of shape change when the shape of a standard press-formed part in FIG. 4 is compared with the shape of a cycle deviation waveform blank press-formed part in FIG. 9.

FIG. 11 is a view illustrating the range of the deviation amount of shape change in FIGS. 7 and 10 in correspondence with the flat blank model.

FIG. 12 is an explanatory diagram of another aspect of the press forming analysis method according to the first embodiment.

FIG. 13 is an explanatory diagram of a press forming analysis apparatus according to a second embodiment.

FIG. 14 is an explanatory diagram of another aspect of the press forming analysis apparatus according to the second embodiment.

FIG. 15 is an explanatory view of a cycle deviation waveform blank model according to an example.

FIG. 16 is an explanatory view of a shape of a cycle deviation waveform blank press-formed part subjected to press forming analysis using the cycle deviation waveform blank model of FIG. 15 (FIG. 16(a)) and FIG. 16(b) is a view illustrating an amount of shape change in FIG. 16(a) in correspondence with the flat blank model (FIG. 16(b)).

FIG. 17 is a view for explaining a deviation amount of shape change when the shape of a standard press-formed part in FIG. 4 is compared with the shape of a cycle deviation waveform blank press-formed part in FIG. 16.

FIG. 18 is a view illustrating the range of the deviation amount of shape change in FIGS. 7 and 17 in correspondence with the flat blank model.

### DESCRIPTION OF EMBODIMENTS

### First Embodiment

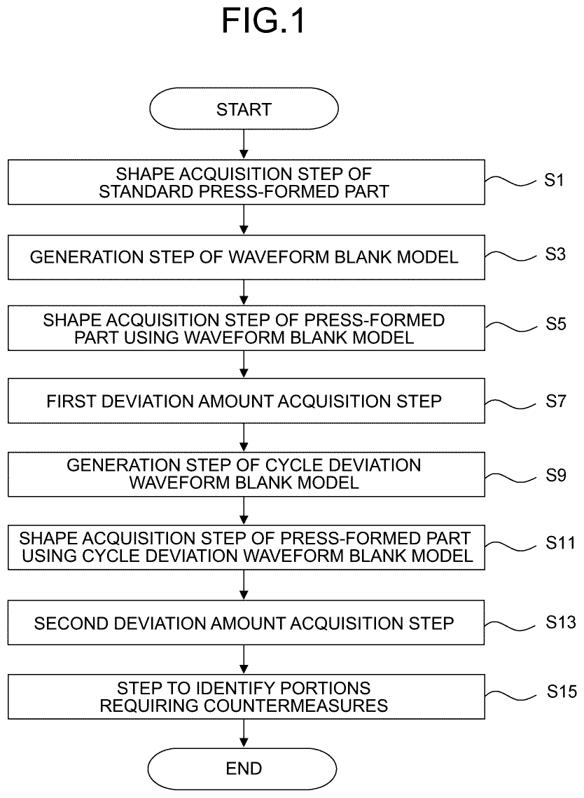

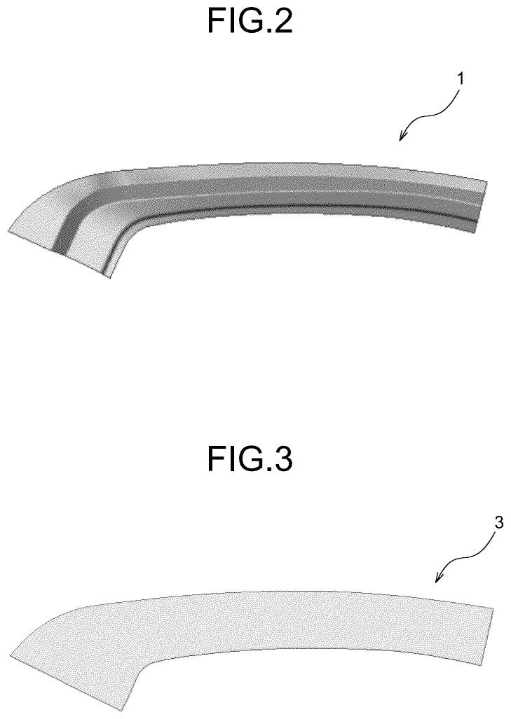

A press forming analysis method according to the present embodiment is a press forming analysis method for predicting an effect of shape variation (unevenness) of a blank when press forming (crash forming, deep drawing, or the like) is performed using the blank collected from a metal sheet having shape variation. As illustrated in FIG. 1, the press forming analysis method according to the present embodiment includes a shape acquisition step S1 of a standard press-formed part, a generation step S3 of a waveform blank model, a shape acquisition step S5 of a press-formed part using a waveform blank model, a first deviation amount acquisition step S7, a generation step S9 of a cycle deviation waveform blank model, a shape acquisition step S11 of a press-formed part using a cycle deviation waveform blank model, a second deviation amount acquisition step S13, and a step S15 to identify portions requiring countermeasures. Hereinafter, each configuration will be described in detail by exemplifying a case where press forming is performed assuming that a press-formed part 1 illustrated in FIG. 2 is a target shape. In the present embodiment, a blank model of a 1.5 G-Pa class steel sheet having a sheet thickness of 1.2 mm is used, but the present invention is not limited thereto.

### <Shape Acquisition Step of Standard Press-Formed Part>

The shape acquisition step S1 of a standard press-formed part is a step of performing press forming analysis with a predetermined tool of press forming model using a flat blank model (hereinafter, referred to as a “flat blank model 3”) as illustrated in FIG. 3, and of acquiring a press-formed part shape after die release as a shape of a standard press-formed part. The “press forming analysis” in the present description includes an analysis for acquiring the shape of a bottom dead center and an analysis for acquiring the shape after die release, that is, after springback (the same applies hereinafter).

The flat blank model 3 is a blank model conventionally and generally used in press forming analysis and has a flat shape without unevenness.

As the press forming analysis, computer aided engineering (CAE) analysis such as a finite element method (FEM) is commonly adopted. The forming by CAE analysis may be crash forming or deep drawing, but in the present embodiment, the case of crash forming will be described as an example.

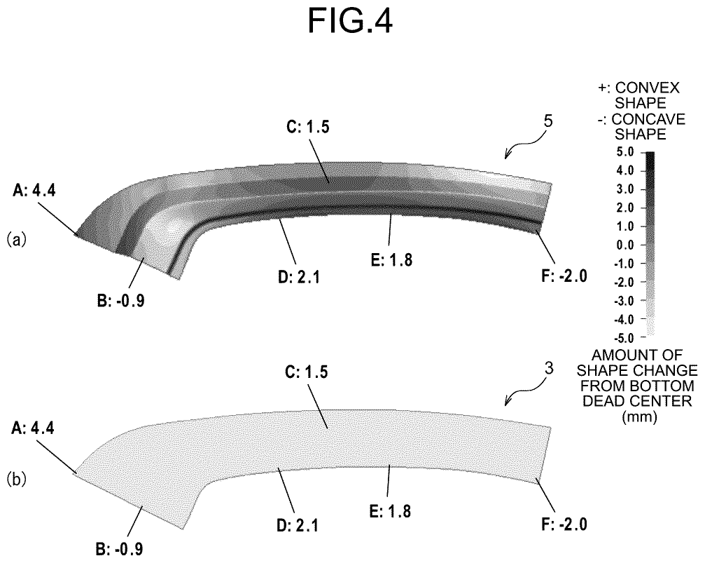

FIG. 4(a) illustrates a shape 5 of the standard press-formed part after die release by press forming analysis. FIG. 4(a) illustrates not only the shape but also the amount of shape change from the bottom dead center using shade of color. The amount of shape change is a value obtained by subtracting the height of the corresponding portion of the shape of the bottom dead center from the height of each portion of the shape of the press-formed part after die release and springback following press forming in the press forming direction, and corresponds to the springback amount in the press forming direction. When the height difference (amount of shape change) is + (positive), the shape is convex with respect to the bottom dead center shape, and when the height difference (amount of shape change) is-(negative), the shape is concave with respect to the bottom dead center shape. In FIG. 4(a), the color of the portion being concave with respect to the bottom dead center is made lighter, and the color of the portion being convex with respect to the bottom dead center is made darker. The number displayed in the drawing indicates an amount of shape change in millimeters; a positive number indicates a change in the convex direction, and a negative number indicates a change in the concave direction.

In the present example, as illustrated in FIG. 4(a), the amounts of shape change were 4.4 mm at the left end portion (portion A) of the shape 5 of the standard press-formed part, −0.9 mm at the left end of the top sheet portion (portion B), 1.5 mm at the center portion in the longitudinal direction (portion C), 1.8 to 2.1 mm at the bottom portion (portions D and E), and −2.0 mm at the right end portion (portion F). In order to indicate the correspondence relationship between the blank shape before press forming and the amount of shape change after springback, FIG. 4(b) illustrates the amounts of shape change at the portions A to F in correspondence with the flat blank model 3.

### <Generation Step of Waveform Blank Model>

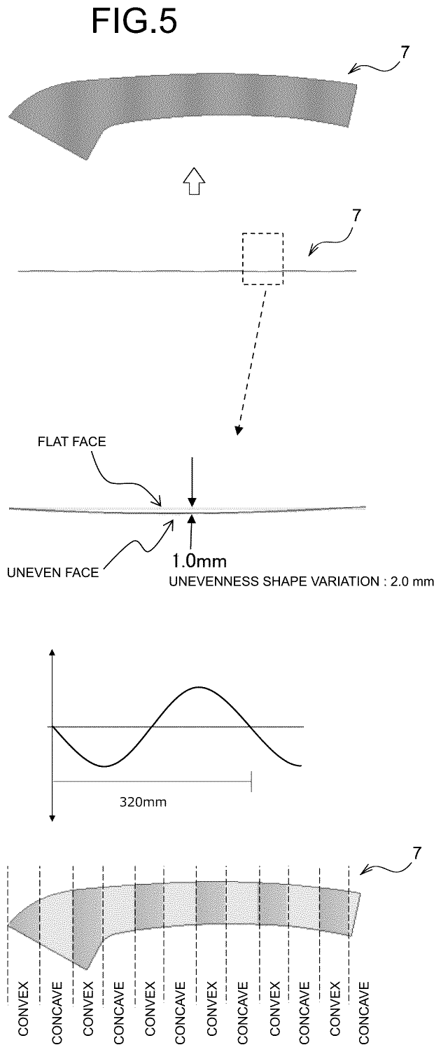

The generation step S3 of a waveform blank model is a step of generating a waveform blank model 7 (see FIG. 5(a)) having a shape corresponding to shape variation of a metal sheet, for example, a waveform resulting from unevenness. A specific shape will be described below.

The example illustrated in FIG. 5(a) is a blank model having a waveform with a predetermined wavelength and a predetermined amplitude. The shade in FIG. 5(a) represents unevenness; a dark-shaded portion has a convex shape protruding toward the front of the paper, and a light-shaded portion has a concave shape recessed toward the back of the paper. FIG. 5(b) illustrates a state of the blank model in FIG. 5(a) viewed from a direction of an open arrow, and FIG. 5(c) is a partially enlarged view of FIG. 5(b). In the example illustrated in FIG. 5, the sheet thickness is 1.2 mm, the amplitude of the unevenness of the shape is 2.0 mm (+1.0 mm), and the wavelength of the unevenness (see FIG. 5(d)) is 320 mm. The start position and the end position of the unevenness set in the blank are not necessarily blank edges. FIG. 5(e) emphasizes portions having unevenness of the shape of FIG. 5(a).

The waveform blank model 7 to be generated in the generation step S3 of a waveform blank model may be generated by measuring the shape of the actual blank collected from the predetermined position of the metal sheet having shape variation with the use of, for example, a laser rangefinder-based 3D shape measuring instrument, and being based on the measurement result (e.g., by using a representative wavelength and amplitude for setting).

### <Shape Acquisition Step of Press-Formed Part Using Waveform Blank Model>

The shape acquisition step S5 of a press-formed part using a waveform blank model is a step of performing press forming analysis where press forming is performed using the waveform blank model 7 with the same predetermined tool of press forming model as that in the shape acquisition step S1 of a standard press-formed part, and of acquiring the shape of the press-formed part after die release as a shape of a waveform blank press-formed part. A shape 9 of the waveform blank press-formed part is illustrated in FIG. 6(a). The colors and numerical values presented in FIG. 6(a) are the same as those in FIG. 4(a).

In the present example, as illustrated in FIG. 6(a), the amounts of shape change were 5.2 mm at the left end portion (portion A) of the shape 9 of the waveform blank press-formed part, −1.0 mm at the left end of the top sheet portion (portion B), 2.3 mm at the center portion in the longitudinal direction (portion C), 2.8 to 4.1 mm at the bottom portion (portions D and E), and −2.5 mm at the right end portion (portion F). FIG. 6(b) illustrates the amounts of shape change at the portions A to F in the shape 9 of the waveform blank press-formed part in correspondence with the waveform blank model 7 before press forming analysis (FIG. 5(e)).

### <First Deviation Amount Acquisition Step>

The first deviation amount acquisition step S7 is a step of comparing the shape 5 of the standard press-formed part (FIG. 4(a)) and the shape 9 of the waveform blank press-formed part (FIG. 6(a)) and obtaining a portion where both the shapes are deviated from each other and a deviation amount of shape change.

In the present embodiment, the shape of the press-formed part at the bottom dead center is defined as a reference shape, and the amount of shape change (springback amount) from the reference shape at each portion of the press-formed part obtained by CAE analysis is obtained. Then, the amount of shape change between the flat blank and the blank having shape variation are compared, and the difference in the amount of shape change due to the shape variation of the blank is obtained as a deviation amount of shape change. That is, the deviation amount of shape change obtained in the first deviation amount acquisition step S7 is a value obtained by subtracting the amount of shape change of the shape 5 of the standard press-formed part using a flat blank (FIG. 4) from the amount of shape change of the shape 9 of the waveform blank press-formed part using the blank having shape variation (FIG. 6). Therefore, when the difference in the amount of shape change (deviation amount of shape change) is + (positive), the portion of the shape 9 of the waveform blank press-formed part has a convex shape as compared with the shape 5 of the standard press-formed part; whereas, when the difference in the amount of shape change (deviation amount of shape change) is-(negative), the portion of the shape 9 of the waveform blank press-formed part has a concave shape as compared with the shape 5 of the standard press-formed part.

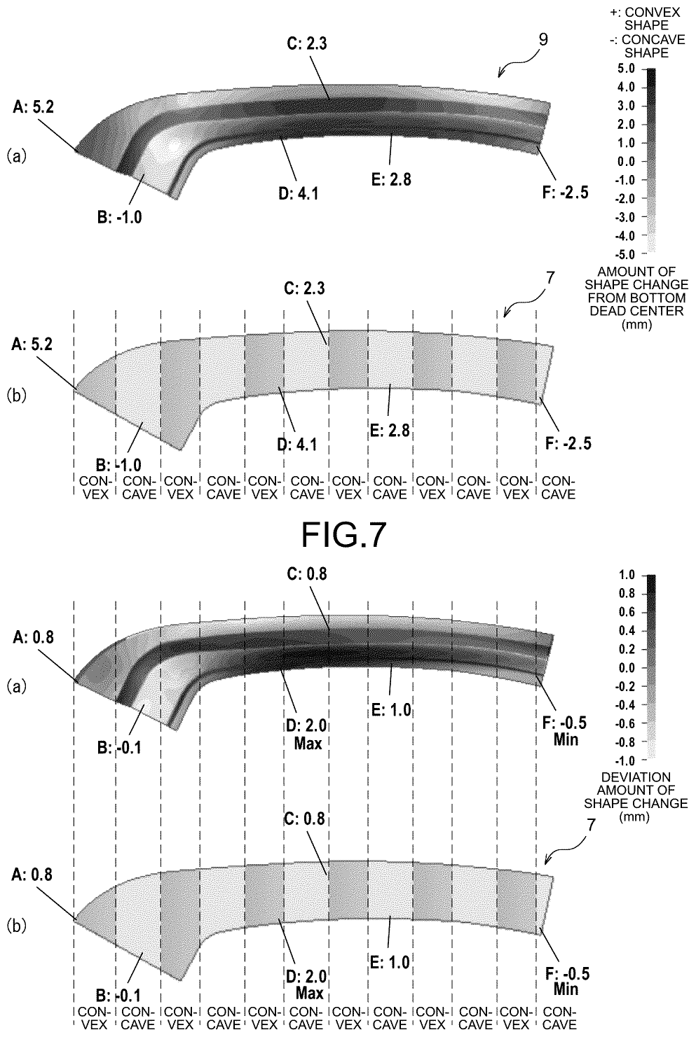

FIGS. 7(a) and 7(b) illustrate the deviation amount of shape change obtained as described above and the unevenness shape of the waveform blank model 7 in correspondence with each other. In the drawing, Max represents the maximum value of the convex shape, and Min represents the maximum value (minimum in terms of numerical value) of the concave shape. As illustrated in FIG. 7(a), the deviation amount of shape change in the case of using the waveform blank model 7 was 0.8 mm at the portion A, −0.1 mm at the portion B, 0.8 mm at the portion C, 2.0 mm at the portion D, 1.0 mm at the portion E, and −0.5 mm at the portion F.

In comparison with FIG. 7(a) and FIG. 7(b), the portion D most greatly deviated in the convex direction is considered to be affected by the convex shape of the corresponding portion of the waveform blank model 7. Similarly, the portion F most greatly deviated in the concave direction is considered to be affected by the concave shape of the corresponding portion of the waveform blank model 7.

For the shape 9 of the waveform blank press-formed part for which the deviation amount of shape change has been obtained, blank development may be performed by analysis of reverse press-forming to identify a portion of the waveform blank model 7 that has an effect on the deviation amount of shape change. The same applies to the second deviation amount acquisition step S13.

### <Generation Step of Cycle Deviation Waveform Blank Model>

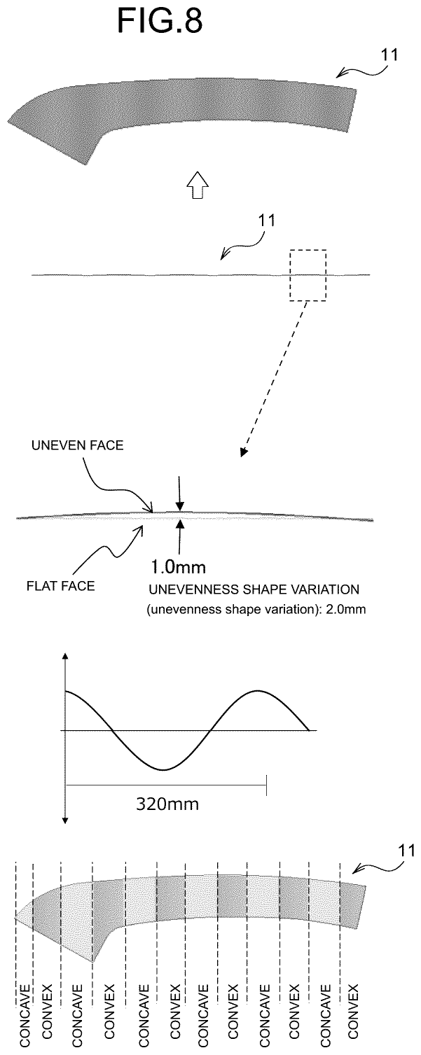

The generation step S9 of a cycle deviation waveform blank model is a step of generating a cycle deviation waveform blank model 11 having a waveform that has a wavelength and an amplitude identical to and a cycle deviated from the waveform of the waveform blank model 7 (see the example of FIG. 8(a)). A specific shape will be described below.

The example illustrated in FIG. 8(a) is a blank model having a cyclic waveform that has a predetermined wavelength and a predetermined amplitude, and the shade in FIG. 8(a) represents unevenness. FIG. 8(b) illustrates a state of the blank model in FIG. 8(a) viewed from a direction of an open arrow, and FIG. 8(c) is a partially enlarged view of FIG. 8(b). In the example illustrated in FIG. 8, the sheet thickness is 1.2 mm, and the amplitude and wavelength of unevenness are the same as those of the waveform blank model 7 in FIG. 5, but the cycle of the waveform is deviated rightward on the paper by ¼ wavelength from that of the waveform blank model 7 (see FIGS. 8(d) and 8(e)).

### <Shape Acquisition Step of Press-Formed Part Using Cycle Deviation Waveform Blank Model>

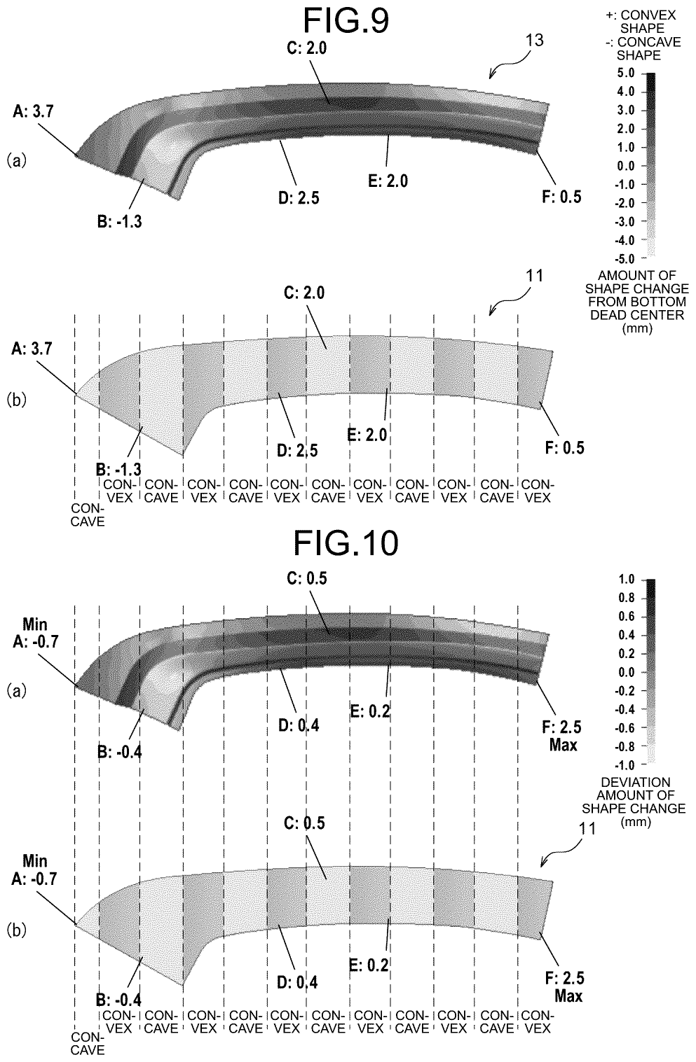

The shape acquisition step S11 of a press-formed part using a cycle deviation waveform blank model is a step of performing press forming analysis where press forming is performed using the cycle deviation waveform blank model 11 with the same predetermined tool of press forming model as that in the shape acquisition step S1 of a standard press-formed part, and acquiring the shape of the press-formed part after die release as the shape of a cycle deviation waveform blank press-formed part. A shape 13 of the cycle deviation waveform blank press-formed part is illustrated in FIG. 9(a). The colors and numerical values presented in FIG. 9(a) are the same as those in FIGS. 4(a) and 6(a).

In the present example, as illustrated in FIG. 9(a), the amounts of shape change were 3.7 mm at the left end portion (portion A) of the shape 13 of the cycle deviation waveform blank press-formed part, −1.3 mm at the left end of the top sheet portion (portion B), 2.0 mm at the center portion in the longitudinal direction (portion C), 2.0 to 2.5 mm at the bottom portion (portions D and E), and 0.5 mm at the right end portion (portion F). FIG. 9(b) illustrates the amounts of shape change at the portions A to F in the shape 13 of the cycle deviation waveform blank press-formed part in correspondence with the cycle deviation waveform blank model 11 before press forming analysis (FIG. 8(e)).

### <Second Deviation Amount Acquisition Step>

The second deviation amount acquisition step S13 is a step of comparing the shape 5 of the standard press-formed part and the shape 13 of the cycle deviation waveform blank press-formed part and obtaining a portion where both the shapes are deviated from each other and a deviation amount of shape change. The method of obtaining the deviation amount of shape change is similar to the method described in the first deviation amount acquisition step S7, and accordingly the description thereof will be omitted.

FIGS. 10(a) and 10(b) illustrate the deviation amount of shape change when the shape 5 of the standard press-formed part (FIG. 4(a)) is compared with the shape 13 of the cycle deviation waveform blank press-formed part (FIG. 9(a)) and the unevenness shape of the cycle deviation waveform blank model 11 in correspondence with each other. The meanings of Max and Min in the drawing are the same as those in FIG. 7. As illustrated in FIG. 10(a), the deviation amount of shape change in the case of using the cycle deviation waveform blank model 11 was −0.7 mm at the portion A, −0.4 mm at the portion B, 0.5 mm at the portion C, 0.4 mm at the portion D, 0.2 mm at the portion E, and 2.5 mm at the portion F.

In comparison with FIG. 10(a) and FIG. 10(b), the portion F most greatly deviated in the convex direction is considered to be affected by the convex shape of the corresponding portion of the cycle deviation waveform blank model 11. Similarly, the portion A most greatly deviated in the concave direction is considered to be affected by the concave shape of the corresponding portion of the cycle deviation waveform blank model 11.

### <Step to Identify Portions Requiring Countermeasures>

The step S15 to identify portions requiring countermeasures is a step of identifying, as a portion requiring countermeasures, a portion having a deviation amount of shape change exceeding a threshold among the deviation amounts of shape change obtained in the first deviation amount acquisition step S7 and the second deviation amount acquisition step S13.

Joining of press-formed parts may be difficult, which requires some countermeasures when there is a large deviation in the shape of the press-formed part (particularly, a flange portion or the like) in some cases, for example, a case where a plurality of press-formed parts is overlapped and joined to be assembled to members of an automotive body. In view of this, in the present embodiment, portions assumed to have a large deviation due to a blank having shape variation are identified as portions requiring countermeasures. This step makes it possible to take countermeasures such as correcting a part of a tool of press forming.

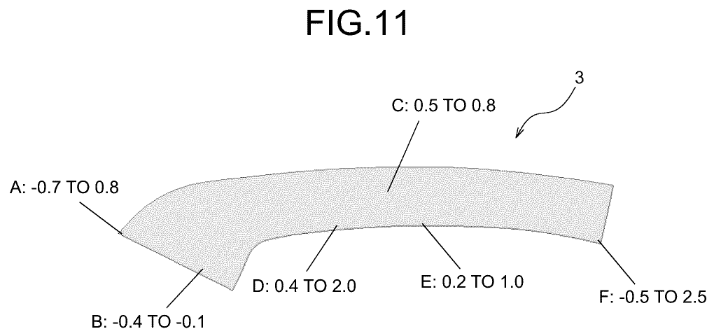

Both the deviation amount of shape change obtained in the first deviation amount acquisition step S7 (see FIG. 7) and the deviation amount of shape change obtained in the second deviation amount acquisition step S13 (see FIG. 10) are illustrated in FIG. 11 in correspondence with the blank shape (illustrated on the flat blank model 3).

For example, assuming that the threshold in the step S15 to identify portions requiring countermeasures is ±1.5 mm, the portion having the deviation amount of shape change exceeding the threshold is the portion D (the deviation amount of shape change obtained in the first deviation amount acquisition step S7 is 2.0 mm) and the portion F (the deviation amount obtained in the second deviation amount acquisition step S13 is 2.5 mm). Therefore, it is possible to take countermeasures such as identifying the portions D and F as the portions requiring countermeasures and correcting a part of the tool of press forming corresponding to such portions.

According to the present embodiment as described above, it is possible to know a portion where the shape variation of the blank has a large effect on the shape of the press-formed part after springback and a deviation amount of shape change attributable to the shape variation. A plurality of patterns of blank models assuming blanks having shape variation are generated and the deviation amount of shape change in each case is obtained. Thus, consideration is given to a difference in shape variation of individual actual blanks. Whether the press-formed part is defective is determined on the basis of the magnitude of the deviation amount of shape change, whereby whether each blank is defective can be predicted. Furthermore, with regard to the portion having a large deviation amount of shape change (exceeding the threshold), it is possible to identify which portion of the blank before press forming is causative of the shape defect, and countermeasures therefor can be taken promptly, leading also to improvement of productivity. As a result, it is possible to grasp the limit of the shape accuracy of a blank that falls within the range of the shape accuracy required for a press-formed part and to stably perform press forming that generates a favorable shape by screening a blank having an appropriate shape and taking countermeasures such as correcting a part of the tool of press forming.

Although only one type of cycle deviation waveform blank model is generated in the above, a plurality of types of cycle deviation waveform blank models may be generated. In this case, the waveforms of the cycle deviation waveform blank models preferably have periods deviated from each other (the wavelengths and the amplitudes are common to the waveform blank models and all the cycle deviation waveform blank models). By increasing the pattern of the blank model assuming the blank having shape variation, the difference in the shape variation of individual actual blanks can be more specifically considered.

In the above description, in comparing the shape of the press-formed part when the blank is flat (shape of a standard press-formed part) with the shape of the press-formed part when the blank has unevenness (shape of a waveform blank press-formed part or shape of a cycle deviation waveform blank press-formed part), the difference in the amount of shape change (springback amount) from the bottom dead center in the press forming direction is defined as the deviation amount of shape change, but the present invention is not limited thereto. For example, the deviation amount of shape change may be a difference obtained by subtracting the height in the press forming direction of each portion of the shape of the press-formed part after die release (after springback) in the case of a flat blank from the height in the press forming direction of each portion of the shape of the press-formed part after die release (after springback) in the case of a blank having unevenness. In this case, however, a fixed point common to the two shapes of press-formed parts need to be set, and the deviation amount of shape change may vary depending on how to select the fixed point. In this regard, as in the present embodiment, the following approach is preferably adopted, such as comparing the amounts of shape change based on the bottom dead center shape that is constant regardless of the shape of a blank. This allows the deviation amount of shape change to be accurately and easily obtained.

In the above, the blank model having the cyclic waveform is generated as the model corresponding to the blank collected from the metal sheet having shape variation, but the blank model reflecting the irregular unevenness shape of an actual blank may be generated. For example, the shape of an actual blank collected from a metal sheet having shape variation may be measured by a laser rangefinder-based 3D shape measuring instrument or the like, and an actual blank model having a shape corresponding to an actual irregular unevenness shape may be generated using the measurement data.

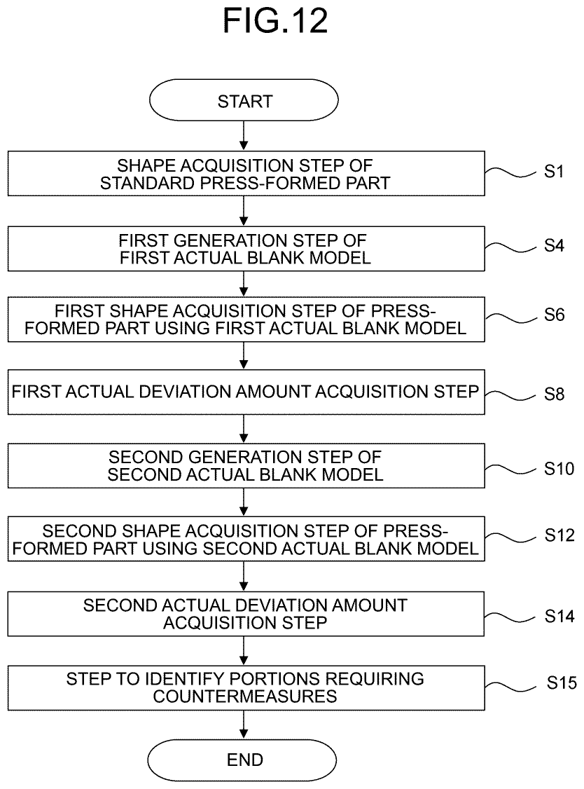

As illustrated in FIG. 12, the press forming analysis method in this case includes: a first generation step S4 of a first actual blank model instead of the generation step S3 of a waveform blank model; a first shape acquisition step S6 of a press-formed part using a first actual blank model instead of the shape acquisition step S5 of a press-formed part using a waveform blank model; a first actual deviation amount acquisition step S8 instead of the first deviation amount acquisition step S7; a second generation step S10 of a second actual blank model instead of the generation step S9 of a cycle deviation waveform blank model; a second shape acquisition step S12 of a press-formed part using a second actual blank model instead of the shape acquisition step S11 of a press-formed part using a cycle deviation waveform blank model; and a second actual deviation amount acquisition step S14 instead of the second deviation amount acquisition step S13. Each step will be specifically described below.

The first generation step S4 of a first actual blank model is a step of measuring the shape of the first actual blank collected from the predetermined position of the metal sheet and generating the first actual blank model based on the measurement result. The first shape acquisition step S6 of a press-formed part using a first actual blank model is a step of performing press forming analysis where press forming is performed using the first actual blank model with the same predetermined tool of press forming model as that in the shape acquisition step S1 of a standard press-formed part, and acquiring the shape of the press-formed part after die release as a first shape of an actual blank press-formed part. The first actual deviation amount acquisition step S8 is a step of comparing the shape of a standard press-formed part and the first shape of the actual blank press-formed part and obtaining a portion where both the shapes are deviated from each other and a deviation amount of shape change.

The second generation step S10 of a second actual blank model is a step of measuring the shape(s) of one or more second actual blank collected from a position of a metal sheet different from that from which the first actual blank is collected and generating one or more types of the second actual blank model based on the measurement result. The second shape acquisition step S12 of a press-formed part using a second actual blank model is a step of performing press forming analysis where press forming is performed using the second actual blank model with the same predetermined tool of press forming model as that in the shape acquisition step S1 of a standard press-formed part, and acquiring the shape of the press-formed part after die release as a second shape of an actual blank press-formed part. The second actual deviation amount acquisition step S14 is a step of comparing the shape of a standard press-formed part and one or more types of the second shape(s) of the actual blank press-formed part(s) and obtaining a portion where both the shapes are deviated from each other and a deviation amount of shape change.

The above is the same as the example of the flow illustrated in FIG. 1 except that a blank model reflecting an irregular unevenness shape of an actual blank collected from a metal sheet having shape variation is generated and used for analysis, and thus detailed description will be omitted. However, the effect can be obtained similarly to the example of FIG. 1.

### Second Embodiment

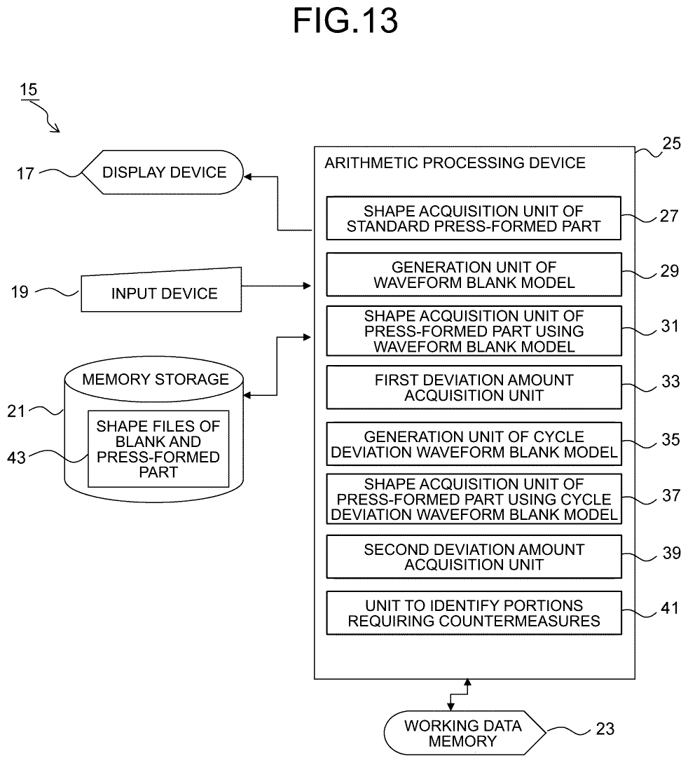

The press forming analysis method described in the first embodiment can be implemented by causing a computer such as a personal computer (PC) to execute a preset program. A press forming analysis apparatus as an example of such an apparatus will be described in the present embodiment. As illustrated in FIG. 13, a press forming analysis apparatus 15 according to the present embodiment is configured by a computer such as a personal computer (PC) and includes a display device 17, an input device 19, a memory storage 21, a working data memory 23, and an arithmetic processing device 25. Then, the display device 17, the input device 19, the memory storage 21, and the working data memory 23 are connected to the arithmetic processing device 25, and each function is executed by a command from the arithmetic processing device 25. Hereinafter, each configuration of the press forming analysis apparatus according to the present embodiment will be described on the assumption that the press-formed part 1 illustrated in FIG. 2 is set as a target to be analyzed.

### <<Display Device>>

The display device 17 is used for displaying an analysis result or the like and includes an LCD monitor or the like.

### <<Input Device>>

The input device 19 is used for applications such as: an instruction to display a blank, a press-formed part or the like; and a condition input by an operator. The input device 19 includes a keyboard, a mouse or the like.

### <<Memory Storage>>

The memory storage 21 is used for storing various files such as shape files 43 of the blank and the press-formed part. The memory storage 21 includes a hard disk or the like.

### <<Working Data Memory>>

The working data memory 23 is used for temporary storage and calculation of data used by the arithmetic processing device 25. The working data memory 23 includes a random access memory (RAM) or the like.

### <<Arithmetic Processing Device>>

As illustrated in FIG. 13, the arithmetic processing device 25 includes a shape acquisition unit 27 of a standard press-formed part, a generation unit 29 of a waveform blank model, a shape acquisition unit 31 of a press-formed part using a waveform blank model, a first deviation amount acquisition unit 33, a generation unit 35 of a cycle deviation waveform blank model, a shape acquisition unit 37 of a press-formed part using a cycle deviation waveform blank model, a second deviation amount acquisition unit 39, and a unit 41 to identify portions requiring countermeasures. The arithmetic processing device 25 includes a central processing unit (CPU) such as a PC. The CPU executes a predetermined program to cause each of these units to function. The functions of each of the above units in the arithmetic processing device 25 will be described below.

The shape acquisition unit 27 of a standard press-formed part executes the shape acquisition step S1 of a standard press-formed part described in the first embodiment. Similarly, the generation unit 29 of a waveform blank model executes the generation step S3 of a waveform blank model, the shape acquisition unit 31 of a press-formed part using a waveform blank model executes the shape acquisition step S5 of a press-formed part using a waveform blank model, the first deviation amount acquisition unit 33 executes the first deviation amount acquisition step S7, the generation unit 35 of a cycle deviation waveform blank model executes the generation step S9 of a cycle deviation waveform blank model, the shape acquisition unit 37 of a press-formed part using a cycle deviation waveform blank model executes the shape acquisition step S11 of a press-formed part using a cycle deviation waveform blank model, the second deviation amount acquisition unit 39 executes the second deviation amount acquisition step S13, and the unit 41 to identify portions requiring countermeasures executes the step S15 to identify portions requiring countermeasures.

As in the first embodiment, with the press forming analysis apparatus 15 according to the present embodiment, it is possible to know a portion where the shape variation of the blank has a large effect on the shape of the press-formed part after springback and a deviation amount of shape change attributable to the shape variation. Since a plurality of patterns of blank models assuming blanks having shape variation are generated and the deviation amount of shape change in each case is obtained, consideration is given to a difference in shape variation of individual actual blanks. Whether the press-formed part is defective is determined on the basis of the magnitude of the deviation amount of shape change, whereby whether each blank is defective can be predicted. Furthermore, with regard to the portion having a large deviation amount of shape change (exceeding the threshold), it is possible to identify which portion of the blank before press forming is causative of the shape defect, and countermeasures therefor can be taken promptly, leading also to improvement of productivity. As a result, it is possible to grasp the limit of the shape accuracy of a blank that falls within the range of the shape accuracy required for a press-formed part and to stably perform press forming that generates a favorable shape by screening a blank having an appropriate shape and taking countermeasures such as correcting a part of the tool of press forming.

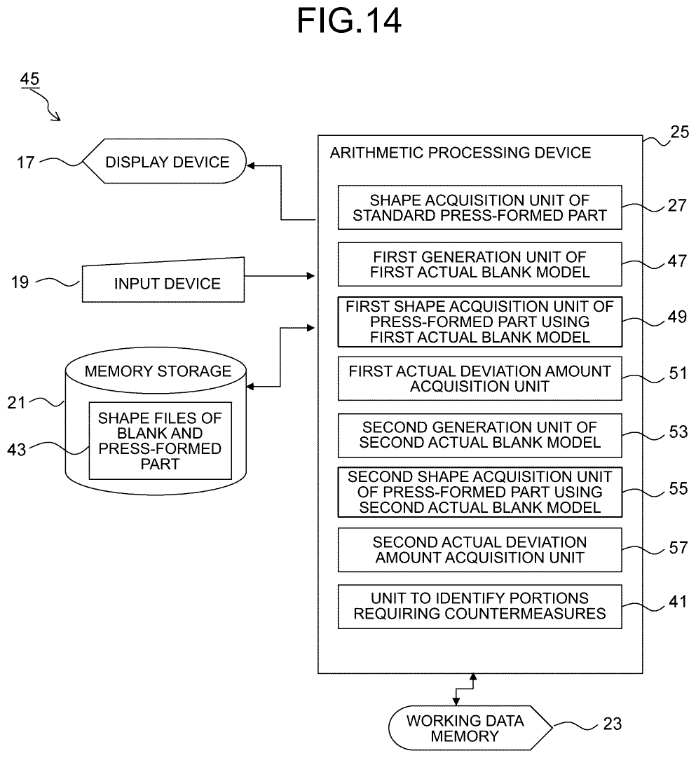

The press forming analysis apparatus 15 of FIG. 13 implements the press forming analysis method of FIG. 1. In a case where the press forming analysis method of FIG. 12 is implemented, a press forming analysis apparatus 45 as illustrated in FIG. 14 can be used. In FIG. 14, the same components as those in FIG. 13 are denoted by the same reference signs, and description thereof will be omitted. The press forming analysis apparatus 45 in FIG. 14 includes: a first generation unit 47 of a first actual blank model instead of the generation unit 29 of a waveform blank model; a first shape acquisition unit 49 of a press-formed part using a first actual blank model instead of the shape acquisition unit 31 of a press-formed part using a waveform blank model; a first actual deviation amount acquisition unit 51 instead of the first deviation amount acquisition unit 33; a second generation unit 53 of a second actual blank model instead of the generation unit 35 of a cycle deviation waveform blank model; a second shape acquisition unit 55 of a press-formed part using a second actual blank model instead of the shape acquisition unit 37 of a press-formed part using a cycle deviation waveform blank model; and a second actual deviation amount acquisition unit 57 instead of the second deviation amount acquisition unit 39.

The first generation unit 47 of a first actual blank model executes the first generation step S4 of a first actual blank model described in another aspect of the first embodiment. Similarly, the first shape acquisition unit 49 of a press-formed part using a first actual blank model executes the first shape acquisition step S6 of a press-formed part using a first actual blank model, the first actual deviation amount acquisition unit 51 executes the first actual deviation amount acquisition step S8, the second generation unit 53 of a second actual blank model executes the second generation step S10 of a second actual blank model, the second shape acquisition unit 55 of a press-formed part using a second actual blank model executes the second shape acquisition step S12 of a press-formed part using a second actual blank model, and the second actual deviation amount acquisition unit 57 executes the second actual deviation amount acquisition step S14. The press forming analysis apparatus 45 also has the same effect as the press forming analysis apparatus 15.

As described above, each unit of the arithmetic processing device 25 in the press forming analysis apparatuses 15 and 45 of the present embodiment is implemented by the CPU executing a predetermined program. Therefore, it can be specified that the press forming analysis program according to the present invention causes a computer to function as the shape acquisition unit 27 of a standard press-formed part, the generation unit 29 of a waveform blank model (or the first generation unit 47 of a first actual blank model), the shape acquisition unit 31 of a press-formed part using a waveform blank model (or the first shape acquisition unit 49 of a press-formed part using a first actual blank model), the first deviation amount acquisition unit 33 (or the first actual deviation amount acquisition unit 51), the generation unit 35 of a cycle deviation waveform blank model (or the second generation unit 53 of a second actual blank model), the shape acquisition unit 37 of a press-formed part using a cycle deviation waveform blank model (or the second shape acquisition unit 55 of a press-formed part using a second actual blank model), the second deviation amount acquisition unit 39 (or the second actual deviation amount acquisition unit 57), and the unit 41 to identify portions requiring countermeasures.

### EXAMPLE

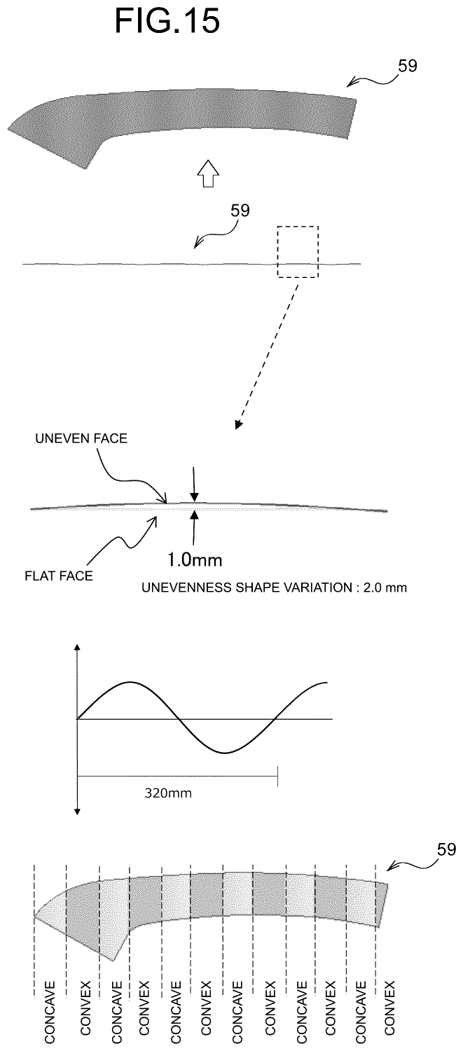

In order to confirm the effect of the present invention, the press forming analysis method described in FIG. 1 was performed. As in the above embodiments, crash forming was adopted as the CAE analysis-based forming in the present examples. A blank model of a 1.5 GPa-class steel sheet having a sheet thickness of 1.2 mm was used. In the present example, the shape acquisition step S1 of a standard press-formed part to the first deviation amount acquisition step S7 were performed as in the first embodiment. Therefore, the flat blank model 3, the shape 5 of the standard press-formed part, the waveform blank model 7, the shape 9 of the waveform blank press-formed part, and the deviation amount of shape change obtained in the first deviation amount acquisition step S7 are similar to those in FIGS. 3 to 7, and thus the description thereof will be omitted. In the present example, in the generation step S9 of a cycle deviation waveform blank model, a cycle deviation waveform blank model 59 different from the cycle deviation waveform blank model 11 of the first embodiment (see FIG. 8) was generated. Hereinafter, steps after the generation step S9 of a cycle deviation waveform blank model in the present example will be described with reference to FIGS. 15 to 18. The numerical values, shade, a convex shape, a concave shape, Max, and Min represented in FIGS. 15 to 18 have the same meanings as those described in the above embodiment.

FIG. 15(a) illustrates the cycle deviation waveform blank model 59 generated in the generation step S9 of a cycle deviation waveform blank model of the present example, and FIG. 15(b) illustrates a state of the blank model in FIG. 15(a) viewed from a direction of an open arrow. FIG. 15(c) is a partially enlarged view of FIG. 15(b). In the example illustrated in FIG. 15, the sheet thickness is 1.2 mm, and the amplitude and wavelength of unevenness are the same as those of the waveform blank model 7 in FIG. 5, but the cycle of the waveform is deviated by ½ wavelength from that of the waveform blank model 7 (see FIGS. 15(d) and 15(e)).

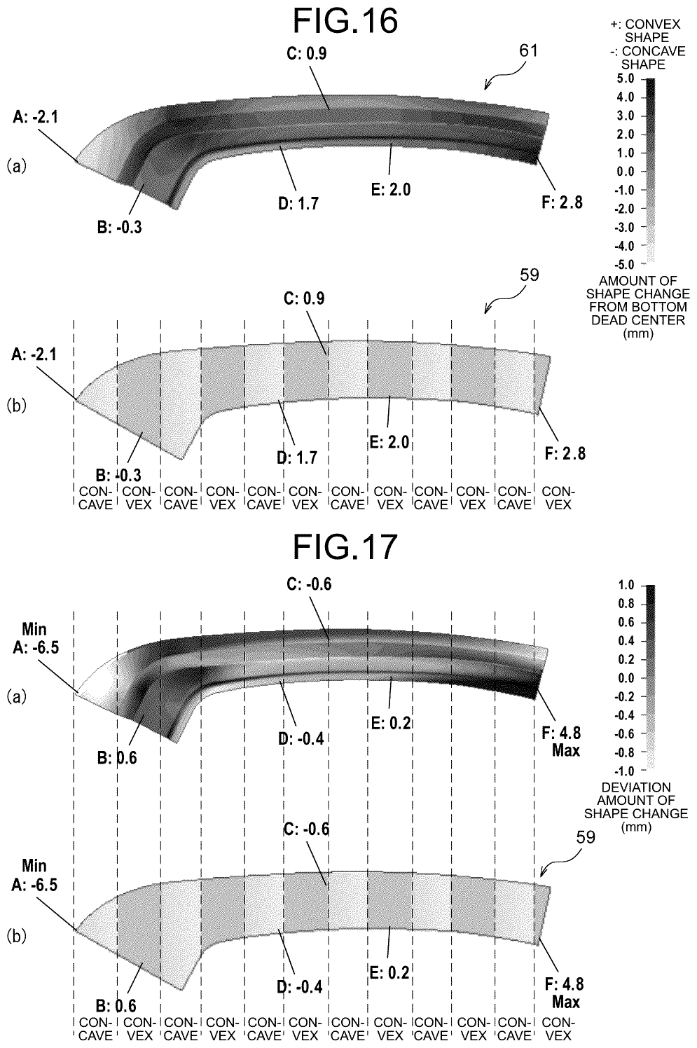

FIG. 16(a) illustrates a shape 61 of a cycle deviation waveform blank press-formed part obtained by performing the shape acquisition step S11 of a press-formed part using a cycle deviation waveform blank model using the cycle deviation waveform blank model 59 of FIG. 15. As illustrated in FIG. 16(a), the amounts of shape change were −2.1 mm at the left end portion (portion A) of the shape 61 of the cycle deviation waveform blank press-formed part, −0.3 mm at the left end of the top sheet portion (portion B), 0.9 mm at the center portion in the longitudinal direction (portion C), 1.7 to 2.0 mm at the bottom portion (portions D and E), and 2.8 mm at the right end portion (portion F). FIG. 16(b) illustrates the amounts of shape change at the portions A to F in the shape 61 of the cycle deviation waveform blank press-formed part in correspondence with the cycle deviation waveform blank model 59 before press forming analysis (FIG. 15(e)).

FIGS. 17(a) and 17(b) illustrate the deviation amount of shape change when the shape 5 of the standard press-formed part is compared with the shape 61 of the cycle deviation waveform blank press-formed part and the unevenness shape of the cycle deviation waveform blank model 59 in correspondence with each other in the second deviation amount acquisition step S13. As illustrated in FIG. 17(a), the deviation amounts of shape change in the case of using the cycle deviation waveform blank model 59 were −6.5 mm at the portion A, 0.6 mm at the portion B, −0.6 mm at the portion C, 0.4 mm at the portion D, 0.2 mm at the portion E, and 4.8 mm at the portion F.

In comparison with FIG. 17(a) and FIG. 17(b), the portion F most greatly deviated in the convex direction is considered to be affected by the convex shape of the corresponding portion of the cycle deviation waveform blank model 59. Similarly, the portion A most greatly deviated in the concave direction is considered to be affected by the concave shape of the corresponding portion of the cycle deviation waveform blank model 59.

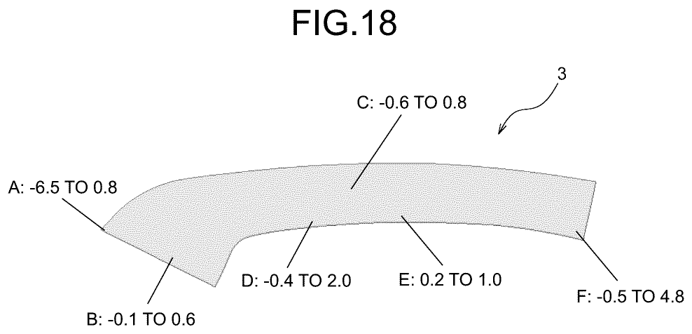

Both the deviation amount of shape change obtained in the first deviation amount acquisition step S7 (see FIG. 7) and the deviation amount of shape change obtained in the second deviation amount acquisition step S13 (see FIG. 17) are illustrated in FIG. 18 in correspondence with the blank shape (illustrated on the flat blank model 3).

In performing joining for assembling the parts constituting an automotive body, the threshold of the step S15 to identify portions requiring countermeasures in the present example was set to +2.0 mm. As a result, the fact that some countermeasures were required for the portion A and the portion F was successively grasped at a glance. Therefore, it is possible to stably manufacture a press-formed part having a favorable shape by taking countermeasures such as correcting the tool of press forming corresponding to the portions, adjusting the portions of the blank, and changing the positions of the blank to be collected from the metal sheet.

### INDUSTRIAL APPLICABILITY

According to the present invention, it is possible to predict the effect of shape variation of a blank on the dimensional accuracy of a press-formed part when press forming is performed using the blank collected from a metal sheet having shape variation and to quickly take countermeasures to improve the dimensional accuracy of the press-formed part. Therefore, the productivity of the press-formed part can be improved.

### REFERENCE SIGNS LIST

1 PRESS-FORMED PART (TARGET SHAPE)
3 FLAT BLANK MODEL
5 SHAPE OF STANDARD PRESS-FORMED PART
7 WAVEFORM BLANK MODEL
9 SHAPE OF WAVEFORM BLANK PRESS-FORMED PART
11 CYCLE DEVIATION WAVEFORM BLANK MODEL
13 SHAPE OF CYCLE DEVIATION WAVEFORM BLANK PRESS-FORMED PART
15 PRESS FORMING ANALYSIS APPARATUS
17 DISPLAY DEVICE
19 INPUT DEVICE
21 MEMORY STORAGE
23 WORKING DATA MEMORY
25 ARITHMETIC PROCESSING DEVICE
27 SHAPE ACQUISITION UNIT OF STANDARD PRESS-FORMED PART
29 GENERATION UNIT OF WAVEFORM BLANK MODEL
31 SHAPE ACQUISITION UNIT OF PRESS-FORMED PART USING WAVEFORM BLANK MODEL
33 FIRST DEVIATION AMOUNT ACQUISITION UNIT
35 GENERATION UNIT OF CYCLE DEVIATION WAVEFORM BLANK MODEL
37 SHAPE ACQUISITION UNIT OF PRESS-FORMED PART USING CYCLE DEVIATION WAVEFORM BLANK MODEL
39 SECOND DEVIATION AMOUNT ACQUISITION UNIT
41 UNIT TO IDENTIFY PORTIONS REQUIRING COUNTERMEASURES
43 SHAPE FILE OF BLANK AND PRESS-FORMED PART
45 PRESS FORMING ANALYSIS APPARATUS (ANOTHER ASPECT)
47 FIRST GENERATION UNIT OF FIRST ACTUAL BLANK MODEL
49 FIRST SHAPE ACQUISITION UNIT OF PRESS-FORMED PART USING FIRST ACTUAL BLANK MODEL
51 FIRST ACTUAL DEVIATION AMOUNT ACQUISITION UNIT
53 SECOND GENERATION UNIT OF SECOND ACTUAL BLANK MODEL
55 SECOND SHAPE ACQUISITION UNIT OF PRESS-FORMED PART USING SECOND ACTUAL BLANK MODEL
57 SECOND ACTUAL DEVIATION AMOUNT ACQUISITION UNIT
59 CYCLE DEVIATION WAVEFORM BLANK MODEL (EXAMPLE)
61 SHAPE OF CYCLE DEVIATION WAVEFORM BLANK PRESS-FORMED PART (EXAMPLE)

1.-9. (canceled)

10. A press forming analysis method for predicting an effect of shape variation of a blank when press forming is performed using the blank collected from a metal sheet having the shape variation, the press forming analysis method comprising:
(a) performing press forming analysis where press forming is performed with a predetermined tool of press forming model using a flat blank model that has a flat shape, and acquiring a shape of a press-formed part after die release as a shape of a standard press-formed part;
(b) generating a waveform blank model having a waveform that has a predetermined wavelength and a predetermined amplitude corresponding to the shape variation;
(c) performing press forming analysis where press forming is performed with the predetermined tool of press forming model using the waveform blank model, and acquiring a shape of the press-formed part after die release as a shape of a waveform blank press-formed part;
(d) comparing the shape of the standard press-formed part and the shape of the waveform blank press-formed part, and obtaining a portion where both the shapes are deviated from each other and a deviation amount of shape change;
(e) generating one or more types of cycle deviation waveform blank models each having a waveform that has an amplitude identical to and a cycle deviated from the waveform in the waveform blank model;
(f) performing press forming analysis where press forming is performed with the predetermined tool of press forming model using the cycle deviation waveform blank model, and acquiring a shape of the press-formed part after die release as a shape of a cycle deviation waveform blank press-formed part;
(g) comparing the shape of the standard press-formed part with one or more types of the shape of the cycle deviation waveform blank press-formed part, and obtaining a portion where both the shapes are deviated from each other and a deviation amount of shape change; and
(h) identifying, as a portion requiring countermeasures, a portion having a deviation amount of shape change exceeding a threshold among the deviation amounts of shape change obtained in (d) and (g).

11. The press forming analysis method according to claim 10, wherein
(d) includes
acquiring, as the deviation amount of shape change, a difference between: a springback amount of a predetermined portion in the shape of the standard press-formed part; and a springback amount of the same portion in the shape of the waveform blank press-formed part as the predetermined portion in the shape of the standard press-formed part, and
(g) includes
acquiring, as the deviation amount of shape change, a difference between: the springback amount of the predetermined portion in the shape of the standard press-formed part; and a springback amount of the same portion in the shape of the cycle deviation waveform blank press-formed part as the predetermined portion in the shape of the standard press-formed part.

12. A press forming analysis method for predicting an effect of shape variation of a blank when press forming is performed using the blank collected from a metal sheet having the shape variation, the press forming analysis method comprising:
(a) performing press forming analysis where press forming is performed with a predetermined tool of press forming model using a flat blank model that has a flat shape, and acquiring a shape of a press-formed part after die release as a shape of a standard press-formed part;
(b) generating a first actual blank model on a basis of a measurement result obtained by measuring a shape of a first actual blank collected from a predetermined position of the metal sheet;
(c) performing press forming analysis where press forming is performed with the predetermined tool of press forming model using the first actual blank model, and acquiring a shape of the press-formed part after die release as a first shape of an actual blank press-formed part;
(d) comparing the shape of the standard press-formed part and the first shape of the actual blank press-formed part, and obtaining a portion where both the shapes are deviated from each other and a deviation amount of shape change;
(e) generating one or more types of second actual blank models on a basis of a measurement result obtained by measuring a shape or shapes of one or more of second actual blanks collected from a position of the metal sheet, the position being different from a position from which the first actual blank is collected;
(f) performing press forming analysis where press forming is performed with the predetermined tool of press forming model using the one or more types of second actual blank models, and acquiring a shape of the press-formed part after die release as a second shape of an actual blank press-formed part;
(g) comparing the shape of the standard press-formed part with one or more types of the second shape of the actual blank press-formed part, and obtaining a portion where both the shapes are deviated from each other and a deviation amount of shape change; and
(h) identifying, as a portion requiring countermeasures, a portion having a deviation amount of shape change exceeding a threshold among the deviation amounts of shape change obtained in (d) and (g).

13. The press forming analysis method according to claim 12, wherein
(d) includes
acquiring, as the deviation amount of shape change, a difference between: a springback amount of a predetermined portion in the shape of the standard press-formed part;
and a springback amount of the same portion in the first shape of the actual blank press-formed part as the predetermined portion in the shape of the standard press-formed part, and
(g) includes
acquiring, as the deviation amount of shape change, a difference between: the springback amount of the predetermined portion in the shape of the standard press-formed part; and a springback amount of the same portion in the second shape of the actual blank press-formed part as the predetermined portion in the shape of the standard press-formed part.

14. A press forming analysis apparatus for predicting an effect of shape variation of a blank when press forming is performed using the blank collected from a metal sheet having the shape variation, the press forming analysis apparatus comprising:
a shape acquisition unit of a standard press-formed part, the shape acquisition unit being configured to perform press forming analysis where press forming is performed with a predetermined tool of press forming model using a flat blank model that has a flat shape, and acquire a shape of a press-formed part after die release as a shape of the standard press-formed part;
a generation unit of a waveform blank model, the generation unit being configured to generate a waveform blank model having a waveform that has a predetermined wavelength and a predetermined amplitude corresponding to the shape variation;
a shape acquisition unit of a press-formed part using the waveform blank model, the shape acquisition unit being configured to perform press forming analysis where press forming is performed with the predetermined tool of press forming model using the waveform blank model, and acquire a shape of the press-formed part after die release as a shape of a waveform blank press-formed part;
a first deviation amount acquisition unit being configured to compare the shape of the standard press-formed part and the shape of the waveform blank press-formed part, and obtain a portion where both the shapes are deviated from each other and a deviation amount of shape change;
a generation unit of a cycle deviation waveform blank model, the generation unit being configured to generate one or more types of cycle deviation waveform blank models each having a waveform that has an amplitude identical to and a cycle deviated from the waveform in the waveform blank model;
a shape acquisition unit of a press-formed part using the cycle deviation waveform blank model, the shape acquisition unit being configured to perform press forming analysis where press forming is performed with the predetermined tool of press forming model using the cycle deviation waveform blank model, and acquire a shape of the press-formed part after die release as a shape of a cycle deviation waveform blank press-formed part;
a second deviation amount acquisition unit being configured to compare the shape of the standard press-formed part with one or more types of the shape of the cycle deviation waveform blank press-formed part, and obtain a portion where both the shapes are deviated from each other and a deviation amount of shape change; and
a unit to identify portions requiring countermeasures, the unit being configured to identify, as a portion requiring countermeasures, a portion having a deviation amount of shape change exceeding a threshold among the deviation amounts of shape change obtained in the first deviation amount acquisition unit and the second deviation amount acquisition unit.

15. The press forming analysis apparatus according to claim 14, wherein
the first deviation amount acquisition unit is being configured to
acquire, as the deviation amount of shape change, a difference between: a springback amount of a predetermined portion in the shape of the standard press-formed part; and a springback amount of the same portion in the shape of the waveform blank press-formed part as the predetermined portion in the shape of the standard press-formed part, and
the second deviation amount acquisition unit is configured to
acquire, as the deviation amount of shape change, a difference between: the springback amount of the predetermined portion in the shape of the standard press-formed part; and a springback amount of the same portion in the shape of the cycle deviation waveform blank press-formed part as the predetermined portion in the shape of the standard press-formed part.

16. A press forming analysis apparatus for predicting an effect of shape variation of a blank when press forming is performed using the blank collected from a metal sheet having the shape variation, the press forming analysis apparatus comprising:
a shape acquisition unit of a standard press-formed part, the shape acquisition unit being configured to perform press forming analysis where press forming is performed with a predetermined tool of press forming model using a flat blank model that has a flat shape, and acquire a shape of a press-formed part after die release as a shape of the standard press-formed part;
a first generation unit of an actual blank model, the first generation unit being configured to measure a shape of a first actual blank collected from a predetermined position of the metal sheet, and generate a first actual blank model on a basis of a measurement result;
a first shape acquisition unit of a press-formed part using the first actual blank model, the shape acquisition unit being configured to perform press forming analysis where press forming is performed with the predetermined tool of press forming model using the first actual blank model, and acquire a shape of the press-formed part after die release as a first shape of an actual blank press-formed part;
a first actual deviation amount acquisition unit configured to compare the shape of the standard press-formed part and the first shape of the actual blank press-formed part, and obtain a portion where both the shapes are deviated from each other and a deviation amount of shape change;
a second generation unit of an actual blank model, the second generation unit being configured to measure a shape or shapes of one or more second actual blanks collected from a position of the metal sheet, the position being different from a position from which the first actual blank is collected, and generate one or more types of second actual blank models on a basis of a measurement result;
a second shape acquisition unit of a press-formed part using an actual blank, the shape acquisition unit being configured to perform press forming analysis when press forming is performed with the predetermined tool of press forming model using the one or more types of second actual blank models, the shape acquisition unit being configured to acquire a shape of the press-formed part after die release as a shape of the press-formed part using the one or more second actual blanks;
a second actual deviation amount acquisition unit being configured to compare the shape of the standard press-formed part with one or more types of the second shape of the actual blank press-formed part, and obtain a portion where both the shapes are deviated from each other and a deviation amount of shape change; and
a unit to identify portions requiring countermeasures, the unit being configured to identify, as a portion requiring countermeasures, a portion having a deviation amount of shape change exceeding a threshold among the deviation amounts of shape change obtained in the first actual deviation amount acquisition unit and the second actual deviation amount acquisition unit.

17. The press forming analysis apparatus according to claim 16, wherein
the first actual deviation amount acquisition unit is configured to
acquire, as the deviation amount of shape change, a difference between: a springback amount of a predetermined portion in the shape of the standard press-formed part; and a springback amount of the same portion in the first shape of the actual blank press-formed part as the predetermined portion in the shape of the standard press-formed part, and
the second actual deviation amount acquisition unit is configured to
acquire, as the deviation amount of shape change, a difference between: the springback amount of the predetermined portion in the shape of the standard press-formed part; and a springback amount of the same portion in the second shape of the actual blank press-formed part as the predetermined portion in the shape of the standard press-formed part.

18. A non-transitory computer readable medium storing a press forming analysis program causing a computer to function as the press forming analysis apparatus according to claim 14.

19. A non-transitory computer readable medium storing a press forming analysis program causing a computer to function as the press forming analysis apparatus according to claim 16.
